(19) United States
(12) Patent Application Publication
(10) Pub. No.: US 2014/0041388 A1
(43) Pub. Date: Feb. 13, 2014

(54) Aircraft Fuel System Test Unit

(71) Applicant: Tronair, Inc., Holland, OH (US)

(72) Inventors: Paul Spinazze, Toledo, OH (US); Sherry Drake, Toledo, OH (US)

(73) Assignee: Tronair, Inc., Holland, OH (US)

(21) Appl. No.: 13/954,186

(22) Filed: Jul. 30, 2013

Related U.S. Application Data
(60) Provisional application No. 61/680,846, filed on Aug. 8, 2012.

(51) Int. Cl. F02C 7/22

(52) U.S. Cl. CPC F02C 7/22
USPC 60/734

(57) ABSTRACT

This aircraft maintenance equipment is a fuel system leak test unit, designed to insure installation integrity of fuel system lines and hoses and to insure that the system is free from any debris generated during the assembly and maintenance process for an aircraft. The unit is designed to check for leaks using vacuum or pressure while monitoring for fuel leaks or bubbles through a clear tube section.

### CROSS REFERENCE TO RELATED APPLICATION

The present patent application is based upon and claims the benefit of provisional patent application No. 61/680,846 filed on Aug. 8, 2012.

### FIELD OF THE INVENTION

The present invention relates to the field of aviation and, more particularly, to the production, commissioning and maintenance of aircraft. Specifically, the invention is a fuel system leak test unit.

### BACKGROUND OF THE INVENTION

Various aircraft maintenance equipment have been developed for maintaining various portions of an aircraft. Aircraft ground servicing, specifically, provides fuel systems, electrical, hydraulic fluid, and gaseous inputs to aircraft at or on remote locations. An aircraft requires routine service and maintenance to operate and keep it airworthy. A number of services to determine whether the aircraft is in a condition to fly or taxi. These services include but not limited to: fuel systems, electrical power, hydraulic power, engine-start capability (bleed-air), landing gear systems, air conditioning or heating of the aircraft's interior, oxygen system and nitrogen systems.

The present invention is based on the technical problem of insuring installation integrity of fuel system tanks, lines and hoses.

### SUMMARY OF THE INVENTION

The present invention provides an apparatus for ground servicing and maintenance of aircraft. The present invention provides a fuel system leak test unit, designed to insure installation integrity of fuel system tanks, lines and hoses and to insure that the system is free from any debris generated during the assembly process for an aircraft. The unit is designed to check for leaks using vacuum or pressure while monitoring for fuel leaks or bubbles through a clear tube section.

The portable aircraft fuel system test cart of this invention comprises: a cart having a mounting surface; and a fuel system leak testing unit mounted on the mounting surface. In a preferred embodiment, the system comprises a clear tube section configured for monitoring for fuel leaks or bubbles through the clear tube section. A source of vacuum or air pressure is connected to the system of fuel lines and hoses.

Other objects and advantages of the present invention will become apparent to those skilled in the art upon a review of the following detailed description of the preferred embodiments and the accompanying drawings.

### IN THE DRAWINGS

FIG. 1 is a perspective view of the test unit of this invention.

FIG. 2 is a side view of the test unit of this invention.

FIG. 3 is a front view of the test unit of this invention.

FIG. 4 is a back view of the test unit of this invention.

FIG. 5 is a general view showing a typical aircraft.

### DETAILED DESCRIPTION OF THE INVENTION

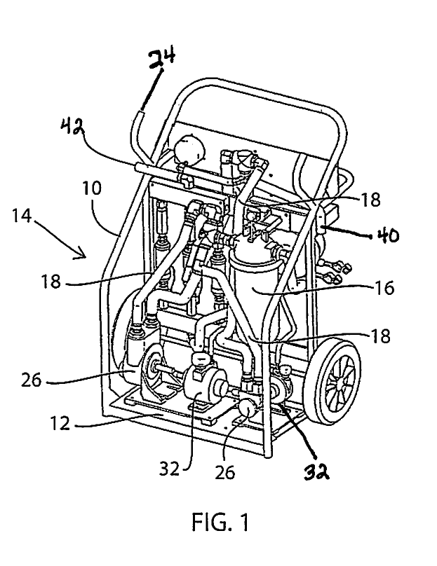

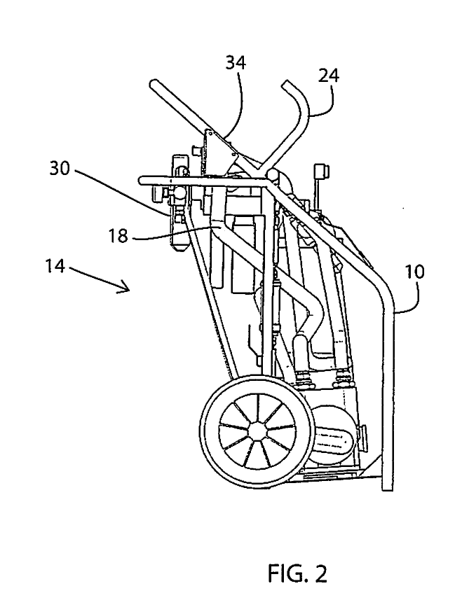

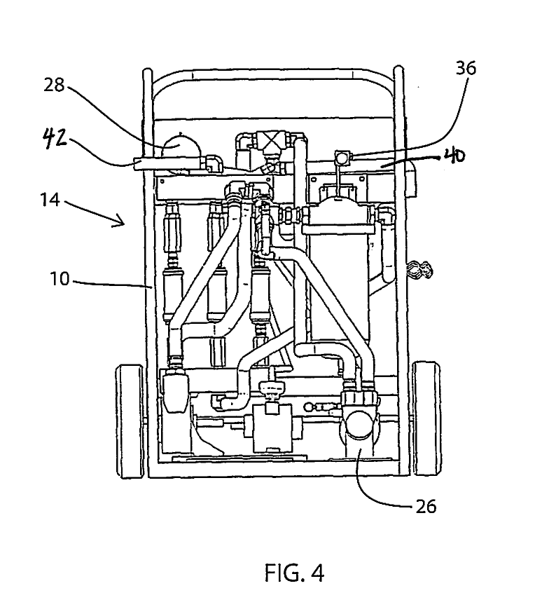

FIGS. 1-4 show the major operating components of this invention: air operated motors, cast iron, rotary valve reversible motors with muffler, static discharge lines. The motor operates in extreme temperatures as well as in wet and corrosive environments, with no heat build-up or electric sparking. Air driven pumps: internal gears of cast iron construction and equipped with Viton seals.

Test cart 10 of this invention comprises two pumps 26, at least one gauge 28 and at least one regulator 30 attached to the system 14 of fuel lines and hoses. The test cart further comprising two air operated motors 32 for driving the pumps 26. Control panel 34 is connected to system 14. Fuel particle filter 16 is attached to the air system wherein the particle filter a 0.5 to micron particle filter. System 14 further comprises suction hose 40 and discharge hose 42.

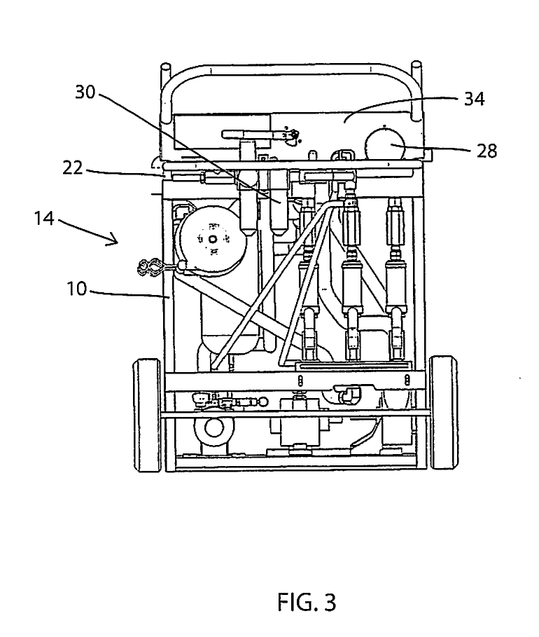

FIG. 3 shows air connection 22. A source of shop air (not shown) is connected to air connection 22. The maximum air pressure typically is 50 psi.

System 14 also includes hose hanger 24, suction hose 40 and discharge hose 42.

Flow meters: three certified flow meters: 0.5-1 gpm, 1.0-5.0 gpm, and 1-15 gpm. The flow meters operate using the variable annular orifice method with compression spring return. The flow meters magnet follower, where the measurement is indicated, is magnetically coupled through a high pressure casing to the meter's internal orifice assembly.

Fuel filter with differential pressure gauge: The fuel filter has ½ micron fuel filtration (98% particle removal efficiency). The differential pressure gauge allows for a simple reading on an easy-to-read scale that alerts the user of the condition of the process.

Air filter, regulator, lubricator: filters have a polypropylene element that removes particles as small as 5 microns. Drain is automatic. Body and bowl are aluminum.

### Specifications:

Welded cart with 12″ diameter wheels
Tool Tray
Air operated pumps
12 GPM maximum flow
50 PSI maximum operating pressure
50 PSI Safety valve
Air inlet control valve
½ micron fuel filtration (98% particle removal efficiency)
20 foot and 50 foot static discharge reels
20 foot suction hose with shutoff valve
40 foot discharge hose
Various suction hose adaptors
Air inlet regulator, pressure gauge, filter and oiler

### Operating Instructions:

1. Check fluid level in air lubricator and air filter sight glass
2. Attach both static discharge lines to aircraft and containment unit
3. Ensure air supply ball valve and air flow control valve are in the off position
4. Attach air supply to unit
5. Slowly open air supply ball valve
6. Adjust regulator pressure as required, do not exceed 50 psi
7. Select high flow or low flow air requirement on control panel
8. Select high flow or low flow fuel pump requirement on control panel
9. Select high flow or low flow fuel pump requirement on unit
10. Select desired flow meter discharge rate
11. Adjust air flow control valve as required to start fuel flow

Static discharge lines are connected to the aircraft and fuel sponson.

Next the operator will connect the suction hose from the cart to the aircraft and the discharge hose from the cart into a fuel sponson. The air hose from the cart will get connected to the customers air supply. The air supply valve is slowly opened and regulated as required ensuring that the air flow control valve is in the off position. The air flow and fuel pump flow is selected based on the testing requirement. Next the flow meter discharge rate is selected on one of the three flow meters. The air flow control valve is then adjusted as required to start the fuel flow and begin fuel system testing.

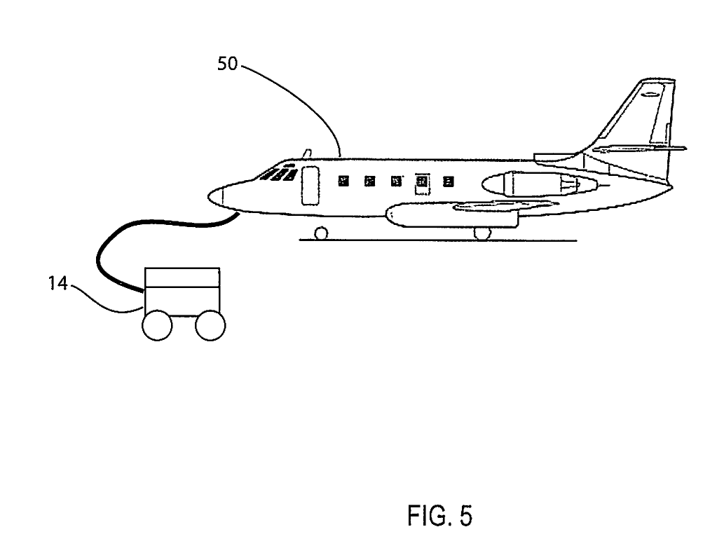

FIG. 5 is a general view showing a typical aircraft with the unit of this invention attached thereto.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A portable aircraft fuel system test cart comprising:
a cart (10) having a mounting surface (12); and
a fuel system leak testing unit (14) mounted on the mounting surface.

2. A test cart according to claim 1 further comprising a system of a fuel particle filter (16), lines and hoses (18) designed to insure installation integrity.

3. A test cart according to claim 2 wherein the system is configured to insure that the system is free from any debris generated during assembly of an aircraft.

4. A test cart according to claim 2 further comprising a source of vacuum or air pressure is connected to air connection (22) connected to the system of fuel lines and hoses (18).

5. A test cart according to claim 2 wherein the system further comprises pumps (26), at least one test gauge (28) and at least one regulator (30) attached to the system of fuel tanks, lines and hoses.

6. A test cart according to claim 6 further comprising an air operated motors (32) for driving the pumps (26).

7. A test cart according to claim 2 further comprising a control panel (34) connected to the system.

8. A test cart according to claim 2 further comprising a particle filter (16) attached to the system.

9. A test cart according to claim 9 wherein the fuel particle filter (16) is a 0.5 to micron particle filter.

10. A test cart according to claim 2 wherein the system further comprises a suction hose (40) and a discharge hose (42).
